(19) United States
(12) Patent Application Publication
(10) Pub. No.: US 2011/0010430 A1
(43) Pub. Date: Jan. 13, 2011

(54) Systems And Methods For Scheduling And Delivering Messages Based On Recipient's Time Zone

(76) Inventors: Ke-Li Wang, Shanghai (CN); Roberto G.F. Sanchez, San Francisco, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/921,419

(22) PCT Filed: Mar. 20, 2008
(86) PCT No.: PCT/CN08/70540

§ 371 Date: Sep. 8, 2010

(51) Int. Cl. G06F 15/16

(52) U.S. Cl. 709/217

(57) ABSTRACT

Systems and methods for scheduling and delivering a message based on a recipient's time zone are provided. In this regard, a representative method, among others, includes receiving parameters that are associated with delivering a message to a recipient. The parameters include information associated with the recipient and the time and date associated with delivering the message. The message includes at least one of the following: text, visual, and audio data format. The method further includes determining a recipient's location based on the received parameters; determining a recipient's time zone based on the determined recipient's location; and scheduling delivery of the message based on the determined recipient's time zone.

### TECHNICAL FIELD

The present disclosure relates to scheduling and delivering messages, and more particularly, the disclosure relates to systems and methods for scheduling and delivering a message based on a recipient's time zone.

### BACKGROUND

Many applications with message delivery features that are based on time evolved with the convergence of telecommunication infrastructure. For example, a telecommunication application server delivers multimedia messages to recipient's mobile phones based on when the message is sent by a subscriber. Because of the delay in message delivery throughout telecommunication networks, the messages arrive at the recipient's mobile phone about 1-2 minutes after the telecommunication application server sends the messages. Thus, the arrival time of the messages can be assumed to be approximately the same as the message delivery time. Currently, the subscriber cannot schedule to send a message to a recipient based on the recipient's local time.

### SUMMARY

Systems and methods for scheduling and delivering a message based on a recipient's time zone are provided. In this regard, a representative method, among others, includes receiving parameters that are associated with delivering a message to a recipient. The parameters include information associated with the recipient and the time and date associated with delivering the message. The message includes at least one of the following: text, visual, and audio data format. The method further includes determining a recipient's location based on the received parameters; determining a recipient's time zone based on the determined recipient's location; and scheduling delivery of the message based on the determined recipient's time zone.

A representative system, among others, includes a delivery engine having instructions stored in memory of a computing device. The instructions include logic configured to receive the parameters from a subscriber; logic configured to determine a recipient's location based on the received parameters; logic configured to determine a recipient's time zone based on the determined recipient's location; and logic configured to schedule delivery of the message based on the determined recipient's time zone.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram that illustrates a system that delivers a message to a recipient based on the recipient's time zone.

FIG. 2 is a high-level flow diagram that illustrates an embodiment of the architecture, functionality, and/or operation of the system, such as that shown in FIG. 1.

FIG. 3 is a sequence diagram of an embodiment of a system, such as that shown in FIG. 1, that delivers the message to the recipient based on the recipient's time zone.

FIG. 4 is a graphical user interface that is generated by a subscriber computing device, such as that in FIG. 1.

FIG. 5 is a block diagram that illustrates an embodiment of a generic computer system that can be used to operate the computing components of the system, such as that shown in FIG. 1.

### DETAILED DESCRIPTION

Exemplary systems are first discussed with reference to the figures. Although these systems are described in detail, they are provided for purposes of illustration only and various modifications are feasible. After the exemplary systems are described, examples of flow diagrams of the systems are provided to explain the manner in which a message can be sent to a recipient based on the recipient's time zone. The message includes at least one of the following: text, visual, and audio data format. From the perspective of a subscriber (or message initiator), the recipient should receive the message at an appropriate time based on the recipient's time zone. For example, Christmas message should be received at 12 p.m. on Christmas Day based on the time zones of respective recipients.

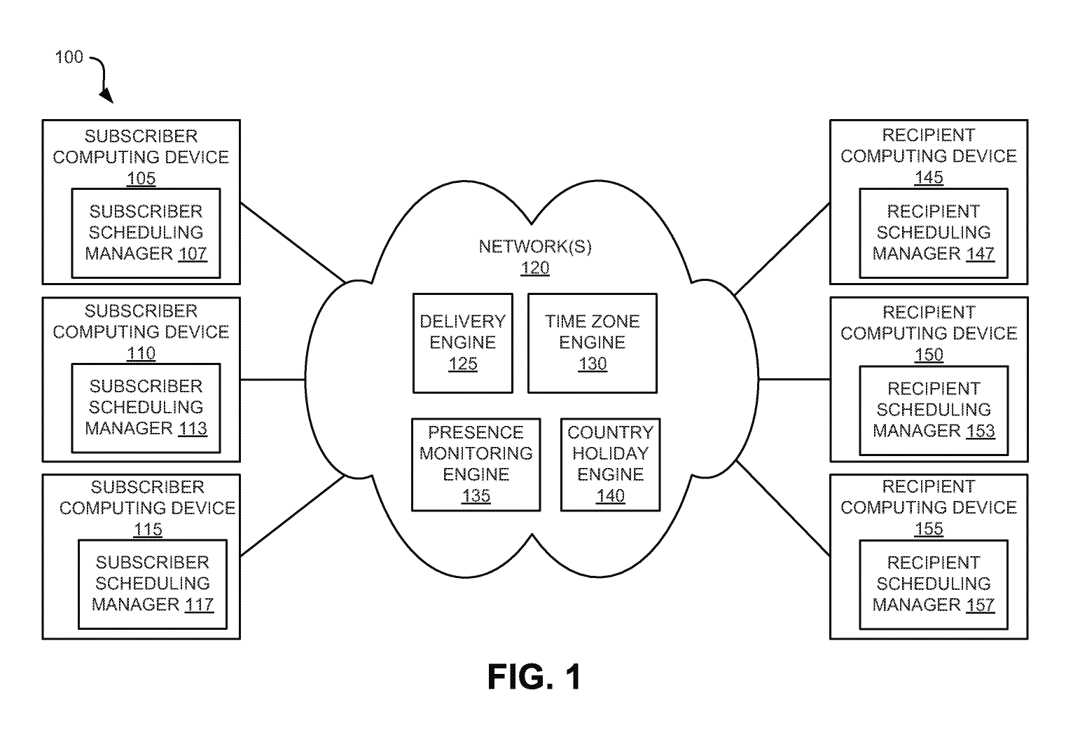

FIG. 1 is a block diagram that illustrates a system that delivers a message to a recipient based on the recipient's time zone. The system 100 includes subscriber computing device(s) 105, 110, 115, network(s) 120 and recipient computing device(s) 145, 150, 155. It should be appreciated that a subscriber configures a delivery of a message via the subscriber computing device 105, 110, 115 and a recipient receives the message via the recipient computing device 145, 150, 155. Thus, subscriber and subscriber computing device 105, 110, 115 are used interchangeably in this disclosure as well as recipient and recipient computing device 145, 150, 155.

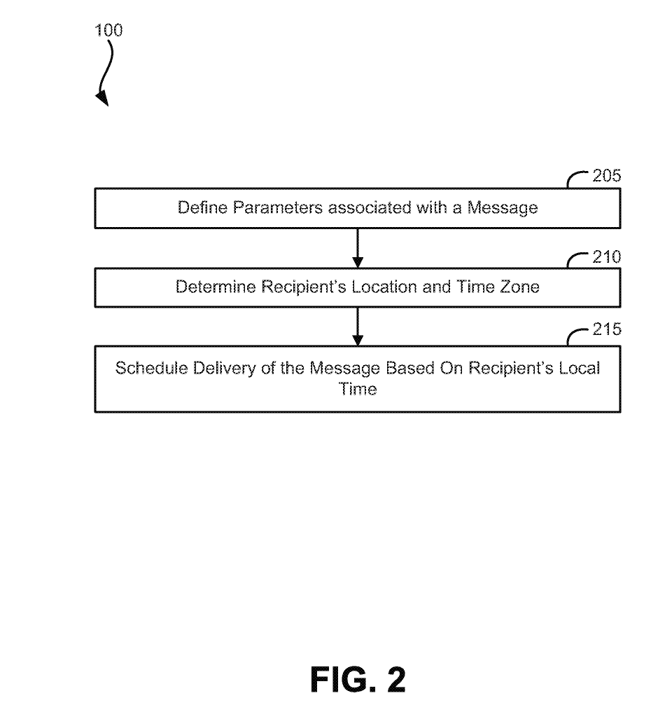

The subscriber computing devices 105, 110, 115 and the recipient computing devices 145, 150, 155 include subscriber scheduling managers 107, 113, 117, and recipient scheduling managers 147, 153, 157, respectively. The subscriber computing devices 105, 110, 115 and the recipient computing devices 145, 150, 155 are connected to the network 120. Such network 120 can include one or more servers (not shown) that include a delivery engine 125, time zone engine 130, presence monitoring engine 135 and country holiday engine 140. The engines 125, 130, 135, 140 are further described in FIGS. 2-5.

The subscriber scheduling manager 107, 113, 117 facilitates defining parameters that are associated with delivering a message to a recipient. The recipient scheduling manager 147, 153, 157 facilitates receiving a message from a subscriber. The subscriber scheduling manager 107, 113, 117 and recipient scheduling manager 147, 153, 157 are further described in relation to FIGS. 2-5.

FIG. 2 is a high-level flow diagram that illustrates an embodiment of the architecture, functionality, and/or operation of the system 100, such as that shown in FIG. 1. In step 205, the system 100 receives parameters that are defined by a user, the parameters of which are associated with delivering a message. For example, the user can send a greeting card to a recipient and the user can define the parameters associated with delivering the greeting card. The parameters include, but are not limited to, identifying one or more recipient and obtaining respective profiles of the recipients, such as time zone and location according to the recipients' phone number, for example. In step 210, the system 100 determines a recipient's location and time zone and in step 215, schedules delivery of the message based on the recipient's local time zone.

Alternatively or additionally, a country holiday engine 140 (FIG. 1) can generate notifications that notify the subscriber about messages associated with a holiday at a recipient's location. For example, if a subscriber and a recipient were located in the United States and China, the system 100 can generate a notification to the subscriber informing her of a Chinese holiday, such as, Chinese New Year, and request whether the subscriber would like to send a message related to the holiday to the recipient.

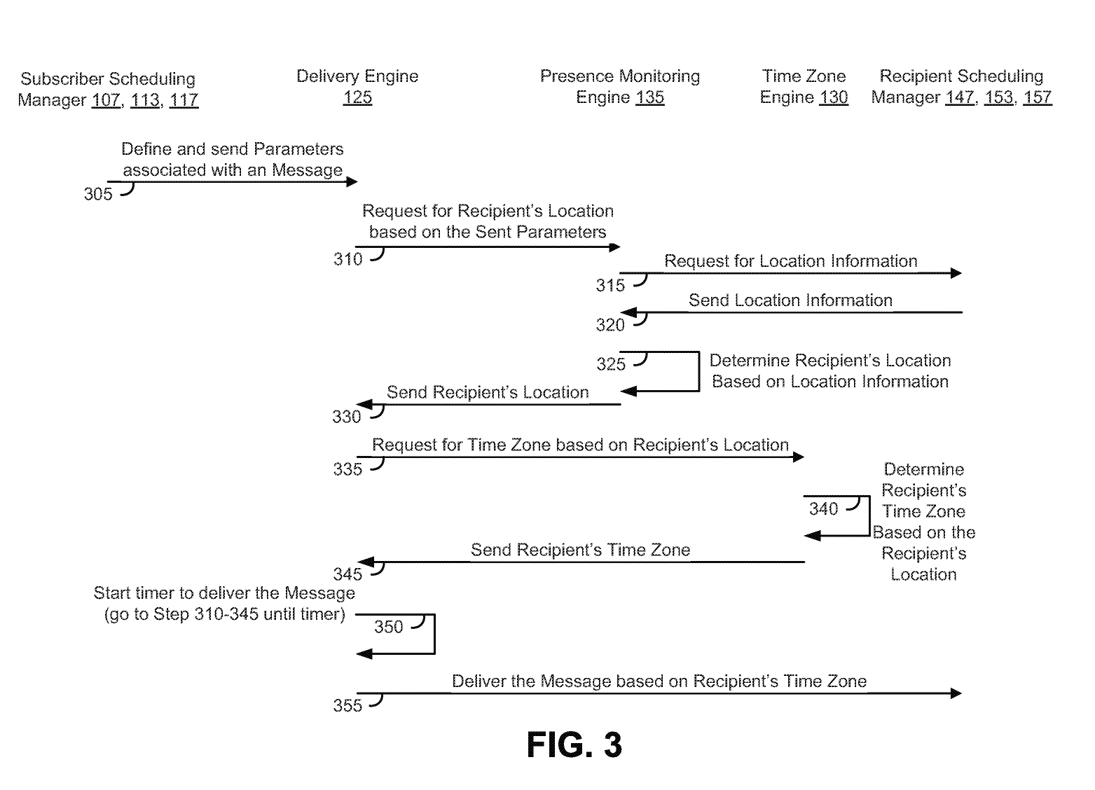

FIG. 3 is a sequence diagram of an embodiment of a system, such as that shown in FIG. 1, that delivers the message to the recipient based on the recipient's time zone. In step 305, a subscriber defines parameters associated with the message and delivery of the message. A subscriber scheduling manager 107, 113, 117 receives and sends the defined parameters to a delivery engine 125. In step 310, the delivery engine 125 sends a request for a recipient's location to a presence monitoring engine 135 based on the defined parameters. The presence monitoring engine 135 generally monitors and tracks the location of the recipient.

In step 315, the presence monitoring engine 135 sends a request for information associated with the recipient's location to a recipient scheduling manager 147, 153, 157, which facilitates determining where the recipient is located. In step 320, the recipient scheduling manager 147, 153, 157 sends the information associated with the recipient's location to the presence monitoring engine 135.

The presence monitoring engine 135 may include cellular, GPS, or any other telecommunication infrastructures that facilitate locating a recipient and determining where the recipient is located. For example, in a mobile network, the subscriber is a customer of a service provider so his location could be retrieved directly from a location server (LS). If the subscriber is roaming to other service providers or customer of other subscribers, his location information could be retrieved from other service provider's external location information proxy using proprietary protocols. The presence monitoring engine 135 can use the location information proxy to acquire the recipient's location information.

In step 325, the presence monitoring engine 135 determines the recipient location based on the information associated with the recipient's location. In step 330, the presence monitoring engine 135 sends the determined recipient location to the delivery engine 125. Alternatively or additionally, the delivery engine 125 can determine the recipient's location based on the recipient's phone number without using the presence monitoring engine 135.

In step 335, the delivery engine 125 sends a request for the recipient's time zone to a time zone engine 130. The time zone engine 130 generally monitors and tracks the recipient's time zone based on the calculated recipient's location. In step 340, the time zone engine 130 determines the recipient's time zone based on the recipient's location. In step 345, the time zone engine 130 sends the determined time zone to the delivery engine 125. Alternatively or additionally, the delivery engine 125 could include the features of the time zone engine 130 such that the deliver engine 125 can determine both the recipient's location and time zone based on the recipient's phone number.

The delivery engine 125 calculates a pre-determined time before the delivery of the message to update the recipient's location and time zone. The predetermined time includes, but is not limited to, 12 or 24 hours before the scheduled time of the delivery of the message. In step 350, the delivery engine 125 starts a timer at the pre-determined time before delivering the message and repeats the steps 310-345 every one (1) hour, for example, to update the recipient's location and time zone in case the recipient is traveling or moving from one location or time zone to another. Responsive to determining that the scheduled time to deliver the message is the same as the updated local time of the recipient and updated time zone of the recipient, the delivery engine 125 delivers the message to the recipient.

Alternatively or additionally, a country holiday engine 140 can generate notifications that notify the subscriber scheduling manager 107, 113, 117 about the messages associated with a holiday at a recipient's location. For example, the country holiday engine 140 can generate a notification to the subscriber informing her of a Chinese holiday, such as, Chinese New Year, that is celebrated at the recipient's location. The country holiday engine 140 requests whether the subscriber would like to send a message related to the holiday to the recipient.

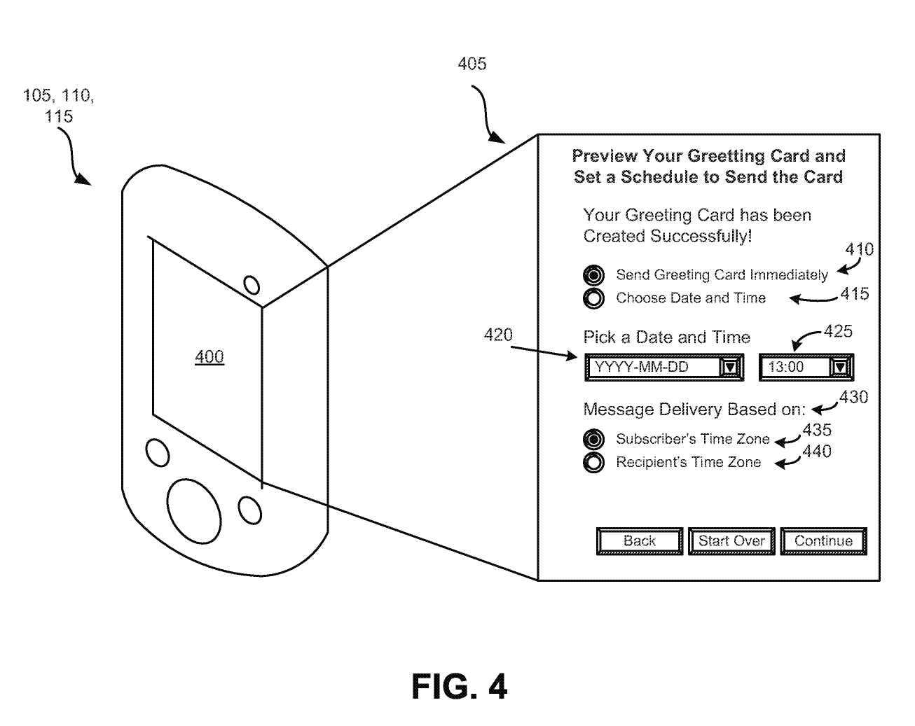

FIG. 4 is a graphical user interface that is generated by a subscriber computing device, such as that in FIG. 1. A subscriber computing device 105, 110, 115 and a recipient computing device 145, 150, 155 include, but are not limited to, a cellular phone, PDA, desktop computer, a laptop, and any other computing devices. The subscriber computing device 105, 110, 115 includes a display 400 that displays a graphical user interface 405 that includes request entries, defining the parameters associated with the recipient and the time and date associated with delivering the message.

The graphical user interface 405 includes an option 410 to send a greeting card, for example, immediately. Another option 415 that is displayed in the graphical user interface 405 can be selected to define a date 420 and time 425 to send the message. Further, the graphical user interface 405 provides an option 430 to deliver the message based on the subscriber's time zone 435 or the recipient's time zone 440. Once the parameters associated with the recipient and the time and date associated with delivering the message are defined by the subscriber, the system 100 facilitates the scheduling and delivering the message to the recipient. Operations of delivering the message are mentioned above in relation to FIGS. 2-3.

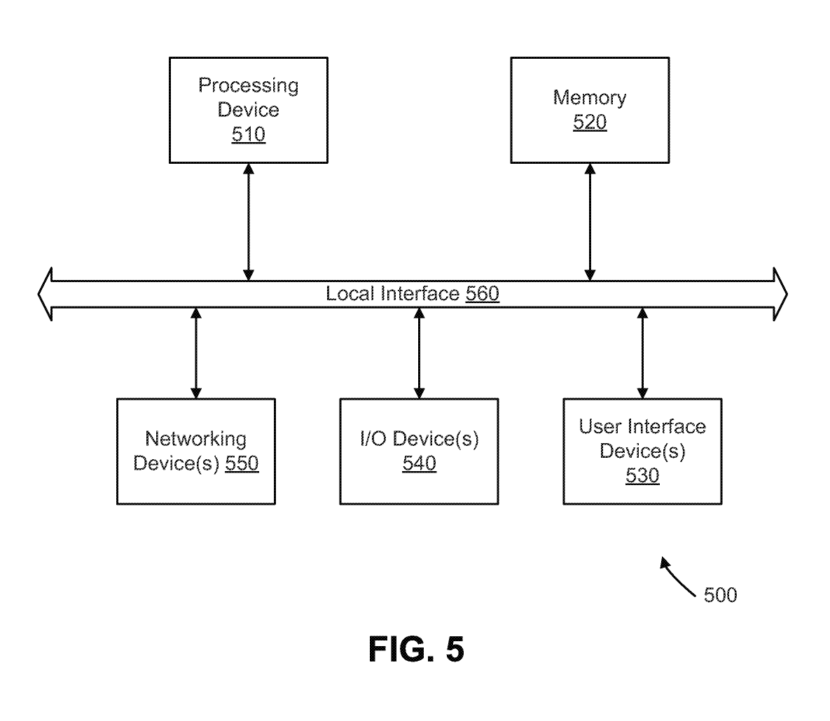

FIG. 5 is a block diagram that illustrates an embodiment of a generic computer system that can be used to operate the computing components of the system, such as that shown in FIG. 1. As indicated in FIG. 5, the generic computer system 500 comprises a processing device 510, memory 520, one or more user interface devices 530, one or more I/O devices 540, and one or more networking devices 550, each of which is connected to a local interface 560.

The processing device 510 can include any custom made or commercially available processor, a central processing unit (CPU) or an auxiliary processor among several processors associated with the subscriber computing device 105, 110, 115, network 120, and recipient computing device 145, 150, 155, a semiconductor based microprocessor (in the form of a microchip), or a macroprocessor. The memory 520 can include any one or a combination of volatile memory elements (e.g., random access memory (RAM, such as DRAM, SRAM, etc.)) and nonvolatile memory elements (e.g., ROM, hard drive, tape, CDROM, Flash Memory, etc.).

The one or more user interface devices 530 comprise those components with which the user (e.g., administrator) can interact with the subscriber computing device 105, 110, 115, one or more servers (not shown) that operates the delivery engine 125, time zone engine 130, presence monitoring engine 135, and country holiday engine 140, and recipient computing device 145, 150, 155. Where the computing components of the system 100 comprise server computers or similar devices, these components can comprise those typically used in conjunction with a PC such as a keyboard and mouse.

The one or more I/O devices 540 comprise components used to facilitate connection of the computing devices of the system 100 to other devices and therefore, for instance, comprise one or more serial, parallel, small system interface (SCSI), universal serial bus (USB), or IEEE 1394 (e.g., Firewire™) connection elements. The networking devices 550 comprise the various components used to transmit and/or receive data over the network 120, where provided. By way of example, the networking devices 550 include a device that can communicate both inputs and outputs, for instance, a modulator/demodulator (e.g., modem), a radio frequency (RF) or infrared (IR) transceiver, a telephonic interface, a bridge, a router, as well as a network card, etc.

The memory 520 of each computing components of the system 100 normally comprises various programs (in software and/or firmware) including an operating system (O/S) (not shown), subscriber scheduling manager 107, 113, 117, recipient scheduling manager 147; 153, 157, delivery engine 125, time zone engine 130, presence monitoring engine 135, and country holiday engine 140, respectively. The O/S controls the execution of programs, including the subscriber scheduling manager 107, 113, 117, recipient scheduling manager 147, 153, 157, delivery engine 125, time zone engine 130, presence monitoring engine 135, and country holiday engine 140, and provides scheduling, input-output control, file and data management, memory management, and communication control and related services. Operations of the subscriber scheduling manager 107, 113, 117, recipient scheduling manager 147, 153, 157, delivery engine 125, time zone engine 130, presence monitoring engine 135, and country holiday engine 140 have been described above in relation to FIGS. 2-3.

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions may be executed out of order from that shown or discussed, including substantially concurrently or in reverse order, depending on the functionality involved.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as is suited to the particular use contemplated. All such modifications and variation are within the scope of this disclosure, as determined by the appended claims when interpreted in accordance with the breadth to which they are fairly and legally entitled.

What is claimed:

1. A method for scheduling and delivering a message based on a recipient's time zone, the method comprising:
receiving parameters associated with delivering a message to a recipient, the parameters including information associated with the recipient and the time and date associated with delivering the message, the message including at least one of the following: text, visual, and audio data format;
determining a recipient's location based on the received parameters;
determining a recipient's time zone based on the determined location; and
scheduling delivery of the message based on the determined time zone.

2. The method as defined in claim 1, further comprising monitoring and tracking the location of the recipient.

3. The method as defined in claim 2, further comprising monitoring and tracking the time zone based on the location of the recipient.

4. The method as defined in claim 1, further comprising updating the recipient's time zone and location.

5. The method as defined in claim 4, further comprising responsive to determining that the time zone and location of the recipient has changed within a predetermined time, updating the recipient's time zone and location such that the message can be delivered based on the received parameters.

6. The method as defined in claim 5, wherein the predetermined time includes 12 or 24 hours before delivering the message based on the determined time zone.

7. The method as defined in claim 1, further comprising generating notifications that notify the subscriber to provide messages associated with a holiday at a recipient's location.

8. A system that is configured to schedule and deliver a message based on a recipient's time zone, the system comprising:
a delivery engine having instructions stored in memory of a computing device, the instructions comprising:
logic configured to receive parameters from a subscriber, the parameters being associated with delivering a message to a recipient, the parameters including information associated with the recipient and the time and date associated with delivering the message, the message including at least one of the following: text, visual, and audio data format;
logic configured to determine a recipient's location based on the received parameters;
logic configured to determine a recipient's time zone based on the determined location; and
logic configured to schedule delivery of the message based on the determined time zone.

9. The system as defined in claim 8, further comprising a presence monitoring engine having instructions stored in memory of the computing device, the instructions comprising logic configured to monitor and track the location of the recipient.

10. The system as defined in claim 8, further comprising a time zone engine having instructions stored in memory of the computing device, the instructions comprising logic configured to monitor and track the time zone based on the location of the recipient.

11. The system as defined in claim 8, wherein the delivery engine is configured to update the recipient's time zone and location.

12. The system as defined in claim 11, wherein responsive to determining that the time zone and location of the recipient has changed within a predetermined time, the delivery engine is configured to update the recipient's time zone and location such that the message can be delivered based on the received parameters.

13. The system as defined in claim 12, wherein the predetermined time includes 12 or 24 hours before delivering the message based on the determined time zone.

14. The system as defined in claim 8, further comprising a country holiday engine having instructions stored in memory of the computing device, the instructions comprising logic configured to generate notifications that notify the subscriber to provide messages associated with a holiday at a recipient's location.

15. A delivery engine that is configured to schedule and deliver a message based on a recipient's time zone, the delivery engine having instructions stored in memory of a computing device, the instructions comprising:
logic configured to receive parameters from a subscriber, the parameters being associated with delivering a message to a recipient, the parameters including information associated with the recipient and the time and date associated with delivering the message, the message including at least one of the following: text, visual, and audio data format;
logic configured to determine a recipient's location based on the received parameters;
logic configured to determine a recipient's time zone based on the determined location; and
logic configured to schedule delivery of the message based on the determined time zone.

16. The delivery engine as defined in claim 15, further comprising logic configured to request information associated with the location of the recipient from a presence monitoring engine, the presence monitoring engine being configured to monitor and track the location of the recipient.

17. The delivery engine as defined in claim 15, further comprising logic configured to request information associated with the time zone of the recipient from a time zone engine, the time zone engine being configured to monitor and track the time zone based on the location of the recipient.

18. The delivery engine as defined in claim 15, further comprising logic configured to update the recipient's time zone and location.

19. The delivery engine as defined in claim 18, further comprising responsive to determining that the time zone and location of the recipient has changed within a predetermined time, logic configured to update the recipient's time zone and location such that the message can be delivered based on the received parameters.

20. The delivery engine as defined in claim 17, wherein the predetermined time includes 12 or 24 hours before delivering the message based on the determined time zone.
